(19) United States
(12) Patent Application Publication
(10) Pub. No.: US 2016/0140195 A1
(43) Pub. Date: May 19, 2016

(54) CUSTOM PARALLIZATION FOR DATABASE TABLE LOADING

(71) Applicant: ORACLE INTERNATIONAL CORPORATION, Redwood Shores, CA (US)

(72) Inventors: Hong GAO, Saint Michael, MN (US); Arun LAL, Eden Prairie, MN (US)

(21) Appl. No.: 14/547,265

(22) Filed: Nov. 19, 2014

(51) Int. Cl. G06F 17/30

(52) U.S. Cl. CPC G06F 17/30563; G06F 17/30592; G06F 17/30339

(57) ABSTRACT

Systems, methods, and other embodiments associated with custom parallelization on a per load operation basis are described. In one embodiment, a method includes identifying a first load operation that loads first data into a first database table, determining a first level of parallelization with which to execute the first load operation, and storing the first level of parallelization for use in future execution of the first load operation. The method includes identifying a second load operation that loads second data into a second database table, determining a second level of parallelization, different from the first level of parallelization, with which to execute the second load operation, and storing the second level of parallelization for use in future execution of the second load operation.

### BACKGROUND

Data warehouses are increasingly used to provide data for business intelligence applications that analyze the data to support the business decision making process. Data warehouses may include DataMarts that are populated with data selected from large quantities of source data. DataMarts have a schema that is optimized for certain types of queries. Often the source data is transformed in some manner prior to being stored in the data warehouse. Aggregation, averaging, and so on, may be performed on the source data so that the data in the data warehouse is better suited for the types of analysis that will be performed by the business intelligence applications.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates one embodiment of a system associated with custom parallelization for database table loading.

FIG. 2 illustrates another embodiment of a system associated with custom parallelization for database table loading.

FIG. 3 illustrates one embodiment of a parallelization configuration table.

FIG. 4 illustrates an embodiment of a method associated with custom parallelization for database table loading.

FIG. 5 illustrates an embodiment of a computing system configured with the example systems and/or methods disclosed.

### DETAILED DESCRIPTION

The process of compiling data warehouses is very processing intensive. Data integrator programs that construct data warehouses include Extract Load and Transform (ELT) routines that execute queries on source data to extract data from the source data, load the extracted data into temporary tables, transform the data in the temporary tables (e.g., aggregate, re-classify, and so on), and then execute queries on the temporary tables to load a destination table with the transformed data. ELT routines also perform merges, joins, and other database operations on source data to construct data warehouse tables. Thus, ELT routines typically include many load operations that each process very large quantities of data. For the purposes of this description, a load operation is to be broadly construed as any operation that participates in the extraction, loading, or transforming of data for the purposes of populating some destination data source (e.g., data warehouse). One example of a load operation is a query that selects data from a source table and stores the results in a destination table. Other load operations include merging or joining of database tables.

Many computer systems support parallel processing in which several processors or servers execute a given instruction, such as a query, on a subset of source data in parallel. Parallel processing can greatly improve performance, but at the cost of typing up valuable resources and possibly creating a bottleneck. Because ELT load operations involve large quantities of data, it may be beneficial to leverage existing parallel processing capabilities to perform the load operations. However, the many ELT load operations involved in creating a given data warehouse each process different quantities of source data. Thus, while many of the load operations will benefit from parallel processing, other load operations may not benefit significantly. Thus, using a global approach to parallel processing may result in some load operations tying up system resources to perform parallel processing without sufficient improvements in performance. This risk may cause some system administrators to avoid using parallel processing even though it may be helpful in many load operations.

Systems and methods are described herein that enable custom parallelization of database table load operations on a per load operation basis. This allows an administrator to tailor parallelization for each load operation based, at least in part, on the quantity of data being processed by the particular load operation. The custom parallelization techniques described herein optimize use of system resources as well as load operation performance. Performance optimization can be especially helpful when the load operations are batch operations that must complete in a limited time window without unnecessarily tying up resources needed to perform other batch operations.

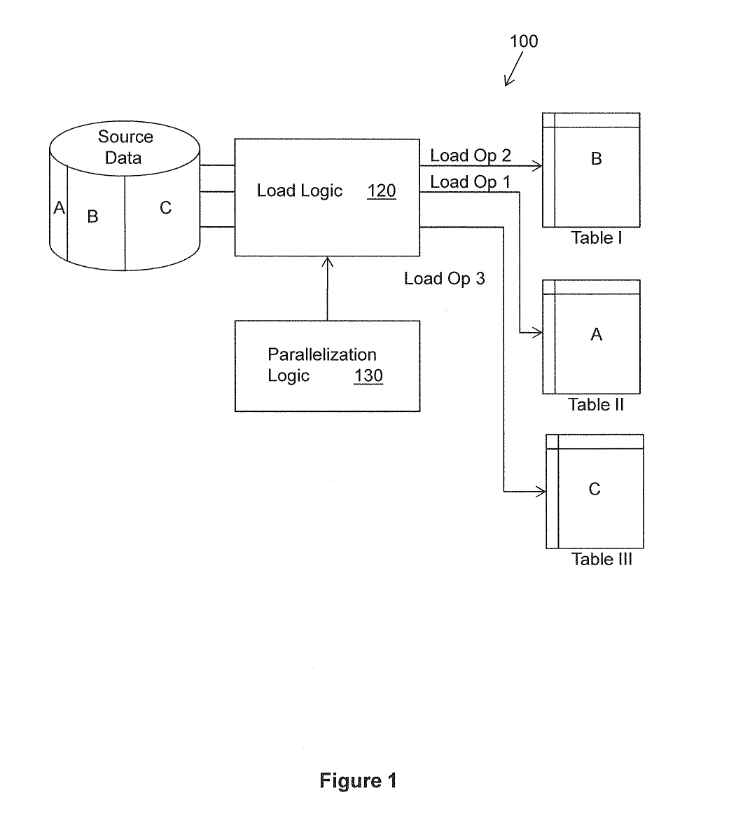

With reference to FIG. 1, one embodiment of a system 100 associated with custom parallelization of database table load operations is illustrated. The system 100 includes a load logic 120 that is configured to perform load operations that extract data from source data, transform the data, and load the data into database tables Table I and Table II. The source data may be data collected by applications that will be used to populate a data warehouse. The database tables Table I and Table II could be temporary tables or data warehouse/DataMart tables.

The source data includes data from three functional areas A, B, and C. Functional area A has relatively little data as compared to functional areas B and C, while functional area C has the most data. For example, in a retail analysis context, functional area A could be for sales adjustment data, functional area B could be for sales data, while functional area C could be for inventory stock on hand data.

The load logic 120 performs a first load operation that loads data from functional area A into Table II, a second load operation that loads data from functional area B into Table I, and a third load operation that loads data from functional area C into Table III. The load logic 120 is controlled by parallelization logic 130 to perform load operations according to prescribed levels of parallelization. For example, given the relative quantities of data in functional areas A, B, and C, the parallelization logic 130 may control the load logic 130 to perform the first load operation with no parallelization, the second load operation with a medium amount of parallelization, and the third load operation with a maximum amount of parallelization.

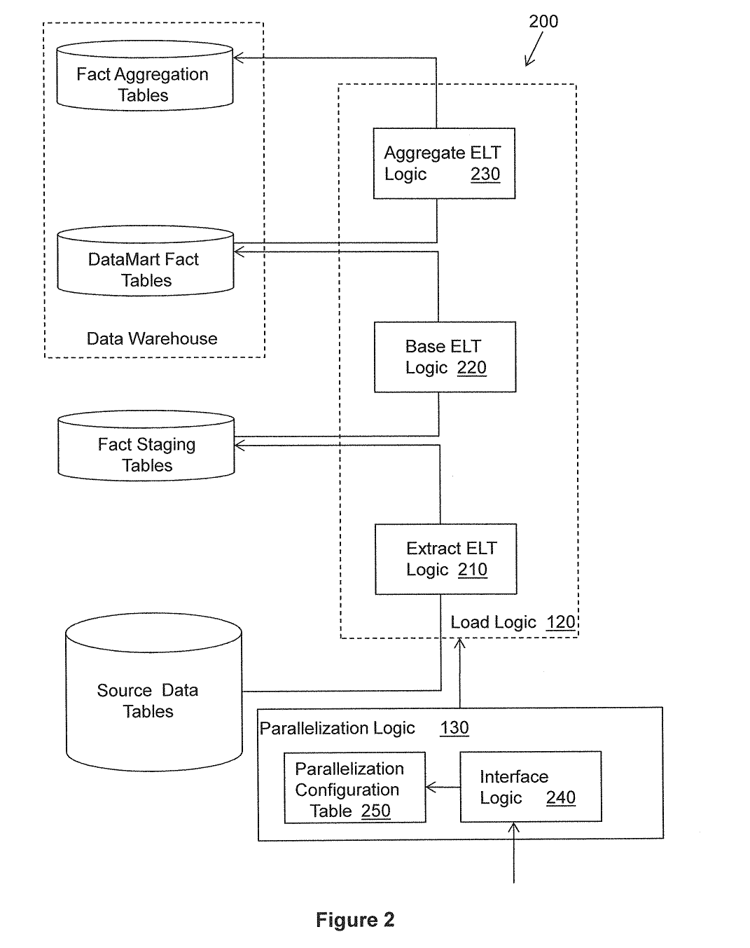

FIG. 2 illustrates one embodiment of a system 200 associated with custom parallelization for database table loading. The system 200 populates a data warehouse that includes DataMart fact tables and fact aggregation tables using data pulled from source data tables. The system 200 includes the load logic 120, which includes extract ELT logic 210, base ELT logic 220, and aggregate ELT logic 230, each of which perform many load operations. The extract ELT logic 210 is configured to extract data from the source data tables and load the extracted data into staging (e.g., temporary) tables. The base ELT logic 220 is configured to load data from the staging fact tables into DataMart fact tables. The load operation performed by the base ELT logic 220 may include a join or merge operation that is performed on data in the staging tables prior to being stored in the DataMart tables. The aggregate ELT logic 230 performs various load operations to aggregate selected data for use in business analysis. For example, aggregate ELT logic 230 may perform sales aggregation on daily, weekly, monthly, seasonally, and yearly bases.

The aggregation ELT logic 230 may also re-classify data for “As-Is” aggregation in which older data is re-classified and re-aggregated according to a new hierarchy. This re-classification process involves joining “ITEM” level fact tables with dimension tables to get changes in facts and then inserting the changed facts into a temporary table. The temporary table is inserted into an aggregation table. Any of these load operations may benefit from parallel processing.

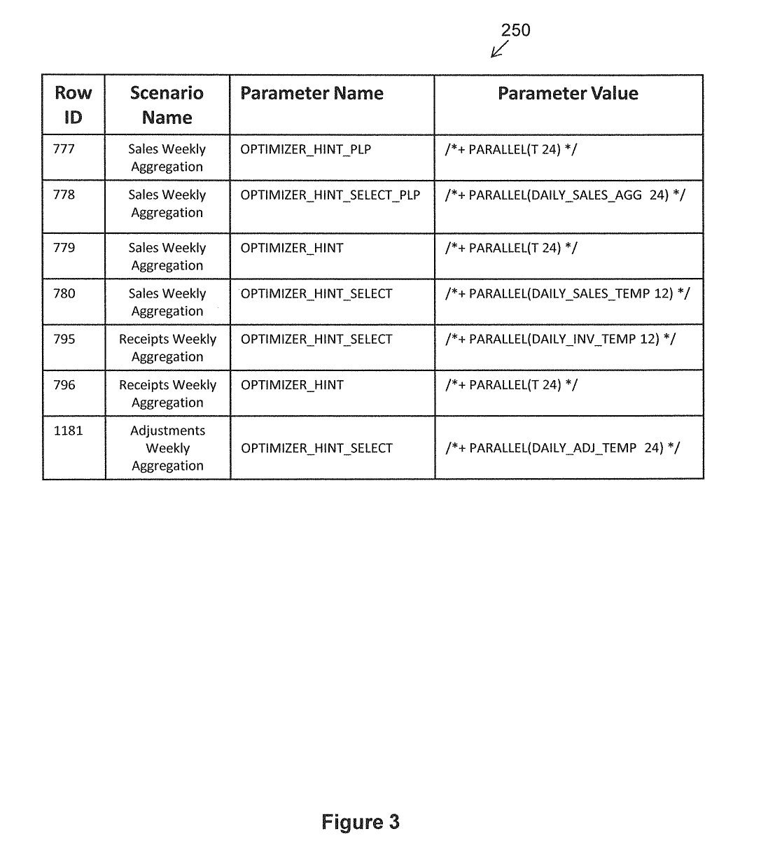

The parallelization logic 130 controls the level of parallelization used for each load operation performed by the extract ELT logic 210, the base ELT logic 220, and the aggregate ELT logic 230. The parallelization logic 130 maintains a parallelization configuration table 250 that maps load operations to levels of parallelization. An example parallelization configuration table 250 is shown in FIG. 3. The parallelization logic 130 also includes an interface logic 240 that provides an interface through which a user may populate the parallelization configuration table 250 with desired levels of parallelization.

FIG. 3 illustrates selected rows of one example of the parallelization configuration table 250. In one embodiment, the parallelization configuration table 250 is a data integrator application configuration table that is used to associate levels of parallelization with different integrator “scenarios.” A scenario is a batch program (e.g., load operation) that populates tables associated with the construction of a data warehouse. The parallelization configuration table 250 uses parameter name/parameter value pairs to configure various load operations. If the scenario name is “global” then the configuration will be applied to all load operations. Otherwise, the configuration is only applied to the scenario identified the scenario name column.

In the configuration table 250, rows 777-780 apply to a sales AS-IS reclassification aggregation load operation. Rows 795-798 apply to an inventory receipt AS-IS reclassification aggregation load operation. Rows 1180-1182 apply to an inventory adjustment AS-IS reclassification load operation.

In the configuration table 250, the level of parallelization is specified by an optimizer hint that is mapped to a scenario. For example, in the first row of the parallelization configuration table 250, the parameter name OPTIMIZER_HINT_PLP has a value of /*+PARALLEL (T 24)*/. This hint specifies the degree of parallelization used for insertion of values into a temporary table. The optimizer hint /*+PARALLEL (T 24)*/ will cause a query optimizer that is optimizing execution of the insertion operation to utilize a 24 degree parallelization. 24 degree parallelization means to utilize 24 different parallel processors to perform the selection operation on 24 different subsets of source data.

In the second row of the parallelization configuration table 250, the parameter name OPTIMIZER_HINT_SELECT_PLP has a value of /*+PARALLEL (DAILY_SALES_AGG 24*/. This hint specifies the degree of parallelization used in selecting values from an ITEM level Daily Sales table. The optimizer hint will cause a query optimizer that is optimizing execution of the selection operation to utilize a 24 degree parallelization.

In the third row of the parallelization configuration table 250, the parameter name OPTIMIZER_HINT has a value of /*+PARALLEL (T 24)*/. This hint specifies the degree of parallelization used in inserting values into a final aggregation table. The optimizer hint will cause a query optimizer that is optimizing execution of the insertion operation to utilize a 24 degree parallelization.

In the fourth row of the parallelization configuration table 250, the parameter name OPTIMIZER_HINT_SELECT has a value of /*+PARALLEL(DAILY_SALES_TEMP 12*/. This hint specifies the degree of parallelization used in selecting values from a temporary table. The optimizer hint will cause a query optimizer that is optimizing execution of the selection operation to utilize a 12 degree parallelization, which is lower than the 24 degree parallelization specified for the load operations of the first three rows of the table 250.

A user can easily change the level of parallelization (e.g., 0-24) to a different level, including 0 for no parallel processing in the configuration table to customize the level of parallelization for their particular implementation.

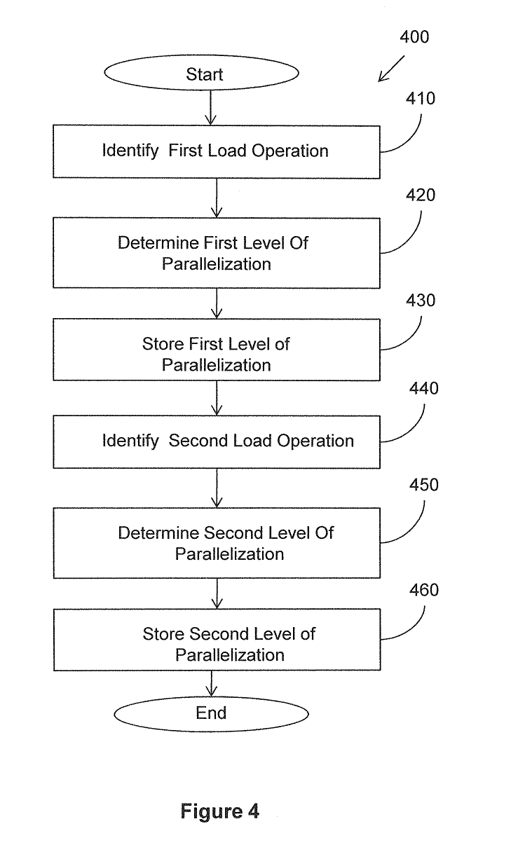

FIG. 4 illustrates a method 400 associated with custom parallelization for database table loading. The method includes, at 410, identifying a first load operation that loads first data into a first database table, where the first data is related to a first functional area. At 420, the method includes determining a first level of parallelization with which to execute the first load operation. At 430, the method includes storing the first level of parallelization for use in future execution of the first load operation. In this manner, when the first load operation is executed to load the first database table, the execution of the first load operation is performed with the first level of parallelization.

The method includes, at 440, identifying a second load operation that loads second data into a second database table, where the second data is related to a second functional area. At 450, the method includes determining a second level of parallelization with which to execute the second load operation. At 460, the method includes storing the second level of parallelization for use in future execution of the second load operation. In this manner, when the second load operation is executed to load the second database table, the execution of the second load operation is performed with the second level of parallelization. The first level of parallelization is different than the second level of parallelization.

In one embodiment, the method includes providing a graphical user interface that prompts a user to enter the first level of parallelization and the second level of parallelization.

In one embodiment, the method includes populating a configuration table that maps the first level of parallelization to the first load operation and the second level of parallelization to the second load operation.

In one embodiment, the first load operation is a first operation that, when executed on a first source table returns the first data; and the second load operation is a second operation that, when executed on a second source table returns the second data. The first level of parallelization is a first optimizer hint that controls a level of parallelization with which the first operation is executed; and the second level of parallelization is a second optimizer hint that controls a level of parallelization with which the second operation is executed. The first optimizer hint specifies a number of processors to be used to execute the first operation; and the second optimizer hint specifies a number of processors to be used to execute the second operation.

In one embodiment, the method includes determining the first level of parallelization based on a quantity of data associated with the first functional area and determining the second level of parallelization based on a quantity of data associated with the second functional area.

As can be seen from the foregoing description, the systems and methods are described herein enable custom parallelization of database table load operations on a per load operation basis. This allows an administrator to tailor parallelization for each load operation based, at least in part, on the quantity of data being processed by the particular load operation. The custom parallelization techniques described herein optimize use of system resources as well as load operation performance.

### Computer Embodiment

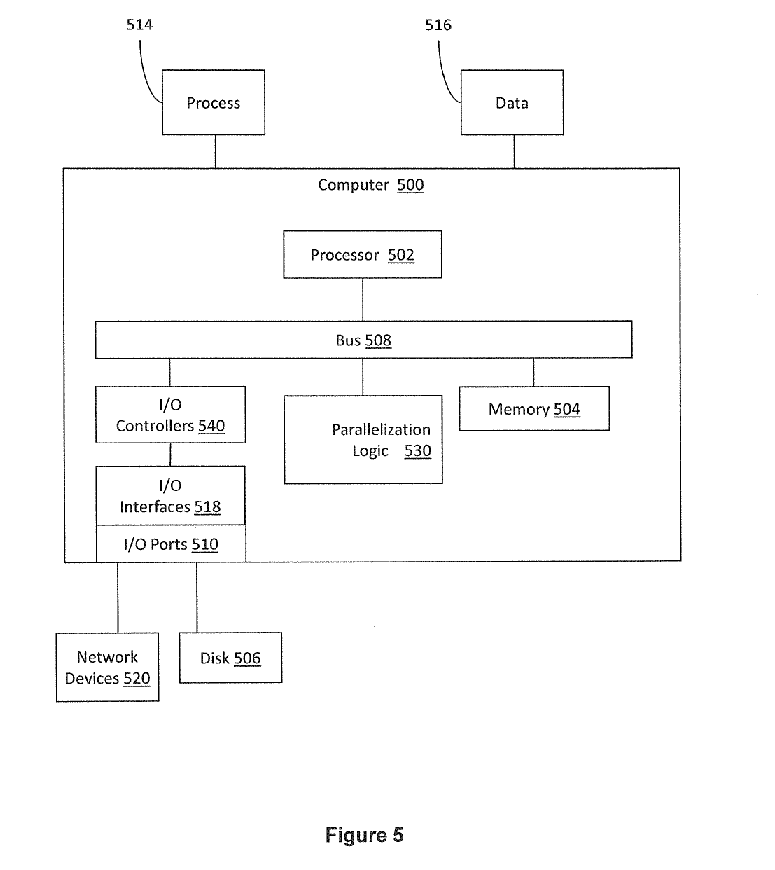

FIG. 5 illustrates an example computing device that is configured and/or programmed with one or more of the example systems and methods described herein, and/or equivalents. The example computing device may be a computer 500 that includes a processor 502, a memory 504, and input/output ports 510 operably connected by a bus 508. In one example, the computer 500 includes parallelization logic 530 configured to control a level of parallelization on a per load operation basis.

The parallelization logic 530 is similar to the parallelization logic 130 described with respect to FIGS. 1 and 2 and in some embodiments performs the method 400 of FIG. 4. In different examples, the parallelization logic 530 may be implemented in hardware, a non-transitory computer-readable medium with stored instructions, firmware, and/or combinations thereof. While the parallelization logic 530 is illustrated as a hardware component attached to the bus 508, it is to be appreciated that in one example, the parallelization logic 530 could be implemented in the processor 502.

In one embodiment, parallelization logic 530, or the computer is a means (e.g., hardware, non-transitory computer-readable medium, firmware) for performing the functions for controlling a level of parallelization on a per load operation basis as described with respect to FIGS. 1-4.

The means may be implemented, for example, as an application specific integrated circuit (ASIC) programmed to perform the functions described with respect to FIGS. 1-4. The means may also be implemented as stored computer executable instructions that are presented to computer 500 as data 516 that are temporarily stored in memory 504 and then executed by processor 502.

Generally describing an example configuration of the computer 500, the processor 502 may be a variety of various processors including dual microprocessor and other multi-processor architectures. A memory 504 may include volatile memory and/or non-volatile memory. Non-volatile memory may include, for example, read-only memory (ROM), programmable ROM (PROM), and so on. Volatile memory may include, for example, random access memory (RAM), static RAM (SRAM), dynamic RAM (DRAM), and so on.

A storage disk 506 may be operably connected to the computer 500 via, for example, an input/output interface (e.g., card, device) 518 and an input/output port 510. The disk 506 may be, for example, a magnetic disk drive, a solid state disk drive, a floppy disk drive, a tape drive, a Zip drive, a flash memory card, a memory stick, and so on. Furthermore, the disk 506 may be a compact disc-ROM (CD-ROM) drive, a CD recordable (CD-R) drive, a CD rewritable (CD-RW) drive, a digital video disk (DVD) ROM, and so on. The memory 504 can store a process 514 and/or a data 516, for example. The disk 506 and/or the memory 504 can store an operating system that controls and allocates resources of the computer 500.

The computer 500 may interact with input/output devices via the I/O interfaces 518 and the input/output ports 510. Input/output devices may be, for example, a keyboard, a microphone, a pointing and selection device, cameras, video cards, displays, the disk 506, the network devices 520, and so on. The input/output ports 510 may include, for example, serial ports, parallel ports, and universal serial bus (USB) ports.

The computer 500 can operate in a network environment and thus may be connected to the network devices 520 via the input/output (I/O) interfaces 518, and/or the I/O ports 510. Through the network devices 520, the computer 500 may interact with a network. Through the network, the computer 500 may be logically connected to remote computers. Networks with which the computer 500 may interact include, but are not limited to, a local area network (LAN), a wide area network (WAN), and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer software embodied in a non-transitory computer-readable medium including an executable algorithm configured to perform the method.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C §101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer-readable medium” or “computer storage medium”, as used herein, refers to a non-transitory medium that stores instructions and/or data configured to perform one or more of the disclosed functions when executed. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C §101.

“Logic”, as used herein, represents a component that is implemented with computer or electrical hardware, firmware, a non-transitory medium with stored instructions of an executable application or program module, and/or combinations of these to perform any of the functions or actions as disclosed herein, and/or to cause a function or action from another logic, method, and/or system to be performed as disclosed herein. Logic may include a microprocessor programmed with an algorithm, a discrete logic (e.g., ASIC), at least one circuit, an analog circuit, a digital circuit, a programmed logic device, a memory device containing instructions of an algorithm, and so on, any of which are configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. Logic is limited to statutory subject matter under 35 U.S.C. §101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. §101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

1. A non-transitory computer storage medium storing computer-executable instructions that when executed by a computer cause the computer to perform a method, the instructions comprising:
instructions for identifying a first load operation that loads first data into a first database table, where the first data is related to a first functional area;
instructions for determining a first level of parallelization with which to execute the first load operation;
instructions for storing the first level of parallelization for use in future execution of the first load operation, such that when the first load operation is executed to load the first database table, the execution of the first load operation is performed with the first level of parallelization;
instructions for identifying a second load operation that loads second data into a second database table, where the second data is related to a second functional area;
instructions for determining a second level of parallelization with which to execute the second load operation;
instructions for storing the second level of parallelization for use in future execution of the second load operation, such that when the second load operation is executed to load the second database table, the execution of the second load operation is performed with the second level of parallelization; and
where the first level of parallelization is different than the second level of parallelization.

2. The non-transitory computer storage medium of claim 1, where the instructions further comprise instructions for displaying a graphical user interface that enables a user to enter the first level of parallelization and the second level of parallelization.

3. The non-transitory computer storage medium of claim 1, where the instructions further comprise instructions for populating a configuration table that maps the first level of parallelization to the first load operation and the second level of parallelization to the second load operation.

4. The non-transitory computer storage medium of claim 1, where:
the first load operation comprises a first operation that, when executed on a first source table returns the first data; and
the second load operation comprises a second operation that, when executed on a second source table returns the second data.

5. The non-transitory computer storage medium of claim 4, where:
the first level of parallelization comprises a first optimizer hint that controls a level of parallelization with which the first operation is executed; and
the second level of parallelization comprise a second optimizer hint that controls a level of parallelization with which the second operation is executed.

6. The non-transitory computer storage medium of claim 5, where:
the first optimizer hint specifies a number of processors to be used to execute the first operation; and
the second optimizer hint specifies a number of processors to be used to execute the second operation.

7. The non-transitory computer storage medium of claim 1, wherein the instructions further comprise instructions for determining the first level of parallelization based on a quantity of data associated with the first functional area and determining the second level of parallelization based on a quantity of data associated with the second functional area.

8. A computing system, comprising:
parallelization logic configured to:
identify a first load operation that loads first data into a first database table, where the first data is related to a first functional area;
determine a first level of parallelization with which to execute the first load operation;
store the first level of parallelization for use in future execution of the first load operation, such that when the first load operation is executed to load the first database table, the execution of the first load operation is performed with the first level of parallelization;
identify a second load operation that loads second data into a second database table, where the second data is related to a second functional area;
determine a second level of parallelization with which to execute the second load operation;
store the second level of parallelization for use in future execution of the second load operation, such that when the second load operation is executed to load the second database table, the execution of the second load operation is performed with the second level of parallelization; and
where the first level of parallelization is different than the second level of parallelization.

9. The computing system of claim 8, where the parallelization logic comprises interface logic configured to display a graphical user interface that enables a user to enter the first level of parallelization and the second level of parallelization.

10. The computing system of claim 8, where the parallelization logic is configured to populate a configuration table that maps the first level of parallelization to the first load operation and the second level of parallelization to the second load operation.

11. The computing system of claim 8, where:
the first load operation comprises a first operation that, when executed on a first source table returns the first data; and
the second load operation comprises a second operation that, when executed on a second source table returns the second data.

12. The computing system of claim 11, where:
the first level of parallelization comprises a first optimizer hint that controls a level of parallelization with which the first operation is executed; and
the second level of parallelization comprise a second optimizer hint that controls a level of parallelization with which the second operation is executed.

13. The computing system of claim 12, where:
the first optimizer hint specifies a number of processors to be used to execute the first operation; and
the second optimizer hint specifies a number of processors to be used to execute the second operation.

14. A computer-implemented method, comprising:
identifying a first load operation that loads first data into a first database table, where the first data is related to a first functional area;
determining a first level of parallelization with which to execute the first load operation;
storing the first level of parallelization for use in future execution of the first load operation, such that when the first load operation is executed to load the first database table, the execution of the first load operation is performed with the first level of parallelization;
identifying a second load operation that loads second data into a second database table, where the second data is related to a second functional area;
determining a second level of parallelization with which to execute the second load operation;
storing the second level of parallelization for use in future execution of the second load operation, such that when the second load operation is executed to load the second database table, the execution of the second load operation is performed with the second level of parallelization; and
where the first level of parallelization is different than the second level of parallelization.

15. The computer-implemented method of claim 14, further comprising displaying a graphical user interface that enables a user to enter the first level of parallelization and the second level of parallelization.

16. The computer-implemented method of claim 14, further comprising populating a configuration table that maps the first level of parallelization to the first load operation and the second level of parallelization to the second load operation.

17. The computer-implemented method of claim 14, where:
the first load operation comprises a first operation that, when executed on a first source table returns the first data; and
the second load operation comprises a second operation that, when executed on a second source table returns the second data.

18. The computer-implemented method of claim 17, where:
the first level of parallelization comprises a first optimizer hint that controls a level of parallelization with which the first operation is executed; and
the second level of parallelization comprise a second optimizer hint that controls a level of parallelization with which the second operation is executed.

19. The computer-implemented method of claim 18, where:
the first optimizer hint specifies a number of processors to be used to execute the first operation; and
the second optimizer hint specifies a number of processors to be used to execute the second operation.

20. The computer-implemented method of claim 14, further comprising determining the first level of parallelization based on a quantity of data associated with the first functional area and determining the second level of parallelization based on a quantity of data associated with the second functional area.
